(19) United States
(12) Patent Application Publication
(10) Pub. No.: US 2005/0176887 A1
(43) Pub. Date: Aug. 11, 2005

(54) Pressure sensitive adhesive and compositions prepared with same

(75) Inventor: David J. St. Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/049,456

(22) Filed: Feb. 2, 2005

Related U.S. Application Data
(60) Provisional application No. 60/542,376, filed on Feb. 6, 2004.

(51) Int. Cl. C08L 51/08

(52) U.S. Cl. 525/63

(57) ABSTRACT

Disclosed is a pressure sensitive adhesive comprising a tackifying resin and a block copolymer having the general formula: S1-B1-S2-B2 wherein S1, B1, S2, and B2 are polymer blocks, and B1 is a block of polymerized conjugated diene comprising at least 50 mole percent isoprene and having an apparent molecular weight of from about 150,000 to about 400,000; S1 and S2 are blocks of polymerized mono-vinylaromatic hydrocarbon having a weight average molecular weight of about 12,000 to about 40,000; and B2 is a block of polymerized conjugated diene comprising at least 50 mole percent isoprene having an apparent molecular weight of from about 15,000 to about 60,000. The weight ratio of B1 over B2 is from about 3.0 to about 12.0; and the content of polymerized mono-vinylaromatic hydrocarbon is from about 10 to about 35 weight percent. The pressure sensitive adhesive can be used in the production of a composition comprising a substrate and adherent thereto the adhesive, such as a label, tape, or a disposable product.

### CROSS-REFERENCE TO RELATED APPLICATIONS

The present application claims the benefit of U.S. Provisional patent application 60/542,376, filed Feb. 6, 2004, entitled Pressure Sensitive Adhesive and Compositions Prepared with Same.

### BACKGROUND OF THE INVENTION

1. Field of the Invention

This invention relates to pressure sensitive adhesives. This invention particularly relates to pressure sensitive adhesives based on block copolymers of mono alkenyl arenes and conjugated dienes.

2. Background of the Art

It is known to prepare adhesives using block copolymers. For example, U.S. Pat. No. 5,292,819 to Diehl, et al., discloses that hot melt adhesives can be prepared using radial block copolymers of styrene and isoprene. These polymers are reported to have an overall molecular weight of from 90,000 to 380,000 and an average polystyrene molecular weight of from 10,000 to 25,000.

A more recent patent also discusses preparing adhesives using block copolymers. U.S. Pat. No. 6,232,391 to Sambasivam, et al., discloses a multipurpose hot melt adhesive comprising an endblock resin in combination with a radial or linear block copolymer of styrene and butadiene having a solution viscosity of greater than 1000 cPs at 25% in toluene. The hot melt adhesive is disclosed as being suitable for both construction and elastic attachment in disposable products.

Disposable products, a major application for adhesives, are reported in U.S. Pat. No. 5,057,571. Therein, it is disclosed that low levels of a radial block copolymer having a molecular weight of greater than about 140,000 can be used to impart a high level of creep resistance, bond strength, and a low viscosity profile in an adhesive. This adhesive is also reported to be useful for both construction and elastic attachment in the preparation of disposable products.

Of course, radial block copolymers are not the only type of copolymers available today to those preparing adhesives. EP 1 348 737 A1 to Trommelen, et al., discloses preparing bituminous compositions using an A1-B1-A2-B2 block copolymer. It is suggested that the polymers disclosed therein may be of use in applications including sound and vibration abatement, adhesives, sealants, and coatings.

Presently, there exists a need for adhesive compositions useful in tapes, labels and disposable articles which have higher service temperatures than can be achieved with conventional polymers. Surprisingly, it has been found that the linear tetrablock copolymers of the present invention serve as essential components of pressure sensitive adhesive formulations which have service temperatures as much as 20° C. higher than can be achieved with conventional polymers at a given polymer content.

### SUMMARY OF THE INVENTION

In one aspect, the present invention is a pressure sensitive adhesive comprising a tackifying resin and a block copolymer having the general formula:
S1-B1-S2-B2
wherein S1, B1, S2, and B2 are polymer blocks, and B1 is a block of polymerized conjugated diene comprising at least 50 mole percent isoprene having an apparent weight average molecular weight of from about 150,000 to about 400,000; S1 and S2 are blocks of polymerized monovinylaromatic hydrocarbon having a weight average molecularweight of about 12,000 to about 40,000; and B2 is a block of polymerized conjugated diene comprising at least 50 mole percent isoprene having an apparent weight average molecular weight of from about 15,000 to about 60,000; and wherein: the adhesive has a shear adhesion failure temperature of at least 75° C.; the weight ratio of B1 over B2 is from about 3.0 to about 12.0; and the content of polymerized monovinylaromatic hydrocarbon is from about 10 to about 35 weight percent.

In another aspect, the present invention is a composition comprising a substrate and adherent thereto a pressure sensitive adhesive prepared from a formulation comprising a tackifying resin and a block copolymer having the general formula:
S1-B1-S2-B2
wherein S1, B1, S2, and B2 are polymer blocks, and B1 is a block of polymerized conjugated diene comprising at least 50 mole percent isoprene having an apparent weight average molecular weight of from about 150,000 to about 400,000; S1 and S2 are blocks of polymerized monovinylaromatic hydrocarbon having a weight average molecular weight of about 12,000 to about 40,000; and B2 is a block of polymerized conjugated diene comprising at least 50 mole percent isoprene having an apparent weight average molecular weight of from about 15,000 to about 60,000; and wherein: the adhesive has a shear adhesion failure temperature of at least 75° C.; the weight ratio of B1 over B2 is from about 3.0 to about 12.0; and the content of polymerized monovinylaromatic hydrocarbon is from about 10 to about 35 weight percent.

In still another aspect, the present invention is an adhesive tape comprising a tape and adherent to at least one side of the tape, a pressure sensitive adhesive prepared from a formulation comprising a tackifying resin and a block copolymer having the general formula:
S1-B1-S2-B2
wherein S1, B1, S2, and B2 are polymer blocks, and B1 is a block of polymerized conjugated diene comprising at least 50 mole percent isoprene having an apparent weight average molecular weight of from about 150,000 to about 400,000; S1 and S2 are blocks of polymerized monovinylaromatic hydrocarbon having a weight average molecular weight of about 12,000 to about 40,000; and B2 is a block of polymerized conjugated diene comprising at least 50 mole percent isoprene having an apparent molecular weight of from about 15,000 to about 60,000; and wherein: the adhesive has a shear adhesion failure temperature of at least 75° C.; the weight ratio of B1 over B2 is from about 3.0 to about 12.0; and the content of polymerized monovinylaromatic hydrocarbon is from about 10 to about 35 weight percent.

### DETAILED DESCRIPTION OF THE PREFERRED EMBODIMENTS

In one embodiment, the present invention is a pressure sensitive adhesive prepared from a formulation comprising a block copolymer having the general formula:
S1-B1-S2-B2
wherein S1, B1, S2, and B2 are polymer blocks, and B1 is a block of polymerized conjugated diene comprising at least 50 mole percent isoprene having an apparent weight average molecular weight of from about 150,000 to about 400,000; S1 and S2 are blocks of polymerized monovinylaromatic hydrocarbon having a weight average molecularweight of about 12,000 to about 40,000; and B2 is a block of polymerized conjugated diene comprising at least 50 mole percent isoprene having an apparent weight average molecular weight of from about 15,000 to about 60,000.

For the purposes of the present invention, weight average molecular weights were measured with gel permeation chromatography (GPC). The term “apparent weight average molecular weight”, as used throughout the present application, means the molecular weight as measured by GPC relative to commercially available polystyrene calibration standards (according to ASTM D6474-99). Thus, the apparent weight average molecular weights of the S1 and S2 blocks are the real or true molecular weights of those blocks. On the other hand, the apparent weight average molecular weights of the B1 and B2 blocks are the weight average molecular weights of the polystyrene standard which would elute at the same time. One skilled in the art can readily convert the apparent molecularweights of B1 and B2 to real ortrue molecularweights using compositionally dependent correction factors.

While isoprene is the preferred conjugated diene for preparing the block copolymer component of the adhesives of the present invention, other suitable conjugated dienes can also be used. For example, 1,3-butadiene, 2,3-dimethyl-1,3-butadiene, 1,3-pentadiene, 1,3-hexadiene and others conjugated dienes having from 4 to 8 carbon atoms can also be used with the present invention. Mixtures of such dienes with isoprene may also be used. Preferably, the blocks of conjugated diene independently comprise at least 50 mole percent, preferable at least about 80 mole percent, and most preferably, at least 99 mole percent isoprene.

Similarly, styrene is the preferred monovinyl aromatic hydrocarbon to prepare the A1 and A2 blocks of the present invention, but other monovinyl aromatic hydrocarbons can also be used. For example, other monovinyl aromatic hydrocarbons useful with the present invention include o-methylstyrene, p-methylstyrene, p-tert-butylstyrene, 2,4-dimethylstyrene, α-methylstyrene, vinyl naphthalene, vinyl toluene and vinyl xylene, or mixtures thereof. Preferably the blocks of polymerized monovinylaromatic hydrocarbon are made of styrene or a mixture independently comprising at least 80 mole percent styrene, the former being preferred. Most preferably, the blocks of polymerized monovinylaromatic hydrocarbon are made of styrene or a mixture independently comprising at least 99 mole percent styrene.

The block copolymers useful with the present invention are preferably poly(styrene-isoprene-styrene-isoprene) polymers. To achieve the properties important to preparing a pressure sensitive adhesive of the present invention, the block copolymer must have the structural and molecular weight limitations as set out above. Thus, B1 has an apparent molecular weight of from about 150,000 to about 400,000. Preferably, B1 has an apparent weight average molecular weight of from about 250,000 to about 350,000. In like manner, B2 has an apparent weight average molecular weight of from about 15,000 to about 60,000, preferably from about 25,000 to about 50,000; and S1 and S2 each independently have a weight average molecular weight of from about 12,000 to about 40,000, preferably from about 20,000 to 35,000.

In the practice of the present invention, according to the general formula, the block copolymers used to prepare the pressure sensitive adhesives of the present invention have a B1 block with a greater apparent molecularweight than the B2 block. The weight ratio “W” of B1 over B2 is from about 3.0 to about 12.0, preferably from about 4.0 to about 8.0. Most preferably, W is about 6.0.

The block copolymers of the present invention have a greater weight content of conjugated diene than monovinyl aromatic hydrocarbon. The content of polymerized monovinyl aromatic hydrocarbon in the block copolymers used to prepare the pressure sensitive adhesives of the present invention is from about 15 to about 30 weight percent. More preferably, the content of polymerized monovinyl aromatic hydrocarbon in the block copolymers used to prepare the pressure sensitive adhesives of the present invention is from 20 to 25 weight percent.

The block copolymers useful with the present invention are preferably prepared by anionic polymerization. The preparation of these block copolymers is well known to those skilled in the art and has been described in U.S. Pat. Nos. 3,265,765; 3,231,635; 3,149,182; 3,238,173; 3,239,478; 3,431,323; Re. 27,145. Typically the polymerization is carried out in a hydrocarbon solvent, such as cyclohexane, using an alkyl lithium initiator, such as sec-butyl lithium. The polymers are preferably prepared by the sequential polymerization method in which each polymer block is prepared by sequential addition of each monomer to the reactor. Any block copolymer having the above described structure and and molecular weights can be used with the present invention.

The pressure sensitive adhesives of the present invention additionally include a tackifying resin. The tackifying resins useful in the practice of the present invention include hydrocarbon resins, synthetic polyterpenes, natural polyterpenes and rosin esters. These resins are preferably semi-solid or solid at ambient temperatures and soften or become liquid at temperatures ranging generally from about 40° C. to about 135° C., preferably from about 70° C. to about 120° C.

Tackifying resins that can be used with the present invention include, but are not limited to: (1) natural and modified rosins such, for example, as gum rosin, wood rosin, tall oil rosin, distilled rosin, hydrogenated rosin, dimerized rosin, and polymerized rosin; (2) glycerol and pentaerythritol esters of natural and modified rosins such, for example, as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; and (3) copolymers and terpolymers of natural terpenes, e.g., styrene/terpene and alpha methyl styrene/terpene. Also useful are (4) polyterpene resins resulting from the polymerization of terpene hydrocarbons, such as the bicyclic monoterpene known as pinene. Other resins that can be used are the hydrogenated polyterpene resins; (5) phenolic modified terpene resins and hydrogenated derivatives thereof such, for example, as the resin product resulting from the condensation, in an acidic medium, of a bicyclic terpene and a phenol; (6) aliphatic petroleum hydrocarbon resins resulting from the polymerization of monomers consisting primarily of olefins and diolefins; also included are the hydrogenated aliphatic petroleum hydrocarbon resins; (7) aromatic petroleum hydrocarbon resins, and mixed aromatic and aliphatic hydrocarbon resins, and the hydrogenated derivatives thereof; (8) aromatic modified alicyclic petroleum hydrocarbon resins and the hydrogenated derivatives thereof; and (9) alicyclic petroleum hydrocarbon resins and the hydrogenated derivatives thereof.

In one embodiment, the tackifying resin is selected from the group consisting of C5 hydrocarbon resins, hydrogenated C5 hydrocarbon resins, styrenated C5 resins, C5/C9 resins, styrenated terpene resins, fully hydrogenated or partially hydrogenated C9 hydrocarbon resins, rosin esters, rosin derivatives, polyterpene resins and mixtures thereof. While the aliphatic hydrocarbon resins and hydrogenated hydrocarbon resins are preferred, any tackifying resin known to those of ordinary skill in the art of preparing pressure sensitive adhesives to be useful can be used with the present invention. The amount of tackifying resin used in the formulation is usually from about 25 parts to about 300 parts by weight per 100 parts of polymer.

The pressure sensitive adhesives of the present invention can additionally include a plasticizing oil, normally one which is preferentially compatible with the B blocks of the block copolymer. Various plasticizing oils are useful in the practice of this invention. The preferred plasticizing oils useful with present invention are the petroleum derived oils which are relatively high boiling materials containing less than 50 percent and in some embodiments only a minor proportion of aromatic hydrocarbons. Alternately, the oil may be totally non-aromatic. Oligomers such as polypropylenes, polybutenes, hydrogenated polyisoprene, hydrogenated polybutadiene, polypiperylene and copolymers of piperylene and isoprene, or the like, having average molecular weights between about 350 and about 10,000 may also be used. Vegetable and animal oils including glyceryl esters of fatty acids and polymerization products thereof may also be used. Any oil known to be useful to those of ordinary skill in the art of preparing pressure sensitive adhesives can be used with the present invention. The amount of plasticizer used is from about zero to about 200 parts by weight per 100 parts of polymer.

Optionally, the adhesive formulation may also contain an arene-block-compatible resin. Normally, the resin should have a softening point above about 100° C. as determined by ASTM E28 using the ring and ball apparatus. Mixtures of arene-block-compatible resins having high and low softening point may also be used. Useful resins include coumarone-indene resins, polystyrene resins, vinyl toluene-alphamethylstryene copolymer resins, alphamethyl styrene resins, polyindene resins, and mixtures thereof. The amount of arene-block-compatible resin varies from about 0 to about 200 parts by weight per 100 parts of polymer.

The pressure sensitive adhesives of the present invention can also include other materials. For example, the pressure sensitive adhesives of the present invention can include an antioxidant. Exemplary antioxidants include high molecular weight hindered phenols and multifunctional phenols such as sulfur and phosphorous-containing phenols. As another example, the pressure sensitive adhesives of the present invention can include fillers. The type and amount of filler can vary depending upon the use to which the pressure sensitive adhesive will be put. Still another example of material useful as a component of the pressure sensitive adhesives of the present invention is a pigment. Where color is an issue, the adhesives of the present invention can be prepared using a pigment that will either mask or allow the pressure sensitive adhesive to stand out in contrast to the substrate upon which it is adhered.

If the adhesive is to be applied from solvent solution, the organic portion of the formulation will be dissolved in a solvent or blend of solvents. Aromatic hydrocarbon solvents such as toluene, xylene or Cyclo Sol 100 (Shell). Also available as aromatic 100 (ExxonMobil) are suitable. Aliphatic hydrocarbon solvents such as hexane, naphtha or mineral spirits may also be used. If desired, a solvent blend consisting of a hydrocarbon solvent with a polar solvent can be used. Suitable polar solvents include esters such as isopropyl acetate, ketones such as methyl isobutyl ketone, and alcohols such as isopropyl alcohol. The amount of polar solvent used depends on the particular polar solvent chosen and on the structure of the particular polymer used in the formulation. Usually, the amount of polar solvent used is between 0 and 50 weight percent in the solvent blend.

In one embodiment, the present invention is a removable tape. Tapes are distinguished from labels in that tapes are load bearing while labels are not, the adhesive on a label being required to merely hold the label in place. Masking tapes provide one example of a removable tape. Masking tapes are often used, for example, to mask surfaces during painting. Typically, a masking tape is applied to a surface, a task such as painting is performed, and then the masking tape is removed when the tape user has finished the task. The tape should be easy to apply, stay in place without lifting or curling under task conditions, and remove cleanly and easily without breaking, damaging the surface, or leaving adhesive residue. In the practice of the present invention, the adhesive can be on at least one side of the tape with a double sided tape being within the scope of the present invention.

One method of preparing adhesives is solvent coating. In solvent coating, the adhesive components are dissolved in a hydrocarbon solvent, the solution is coated onto a backing, and the coated product is dried to remove the solvent. The solvent coating process is particularly applicable to tapes and also labels.

In another embodiment, the pressure sensitive adhesives of the present invention are applied to a substrate as a hot melt adhesive. In a hot melt adhesive process, the adhesive is heated to a point where it can be applied directly to a substrate. Usually the substrate is a tape, label, or a disposable article. Occasionally, the substrate is a transfer sheet and the adhesive is then brought into contact with a second substrate with a greater affinity for the adhesive than the first substrate. The first substrate can be removed leaving the adhesive on the second substrate.

For tack properties of the adhesives, Rolling Ball Tack (in units of cm) was measured by ASTM D3121 and Polyken Probe Tack (in units of kg) was measured by ASTM D2979. Adhesion to stainless steel (in units of pounds force per inch of tape width) was measured by the 180° Peel test, ASTM D903. Shear strength (in units of hours) to stainless steel was measured by the Holding Power test, ASTM D6463, using a 0.5 inch by 0.5 inch contact area and a 2 kg load. Upper service temperature was measured by the Shear Adhesion Failure Temperature (SAFT) test, ASTM D4498. In the SAFT test, bonds 1 inch by 1 inch were formed of adhesive, on a Mylar (polyester) backing, to adhesive on another strip of Mylar, using a 4.5 pound rubber roller. The assembly was suspended vertically in an oven at 38° C., and allowed to come to equilibrium. A 0.5 kg weight was suspended from the free end of the adhesive tape, and the temperature was raised at 22° C./hr. The temperature at which the bond softened and the weight fell was recorded. SAFT was reported as the average of two such determinations. Adhesive melt viscosity (in units of Pa·s) was measured with a Brookfield Thermocell viscometer according to ASTM D3236.

The adhesives of the present invention are particularly useful in construction of disposable articles such as disposable diapers, sanitary pads, and the like. The disposable articles are most frequently prepared using a hot melt construction adhesive. Suitable adhesives must possess a low melt viscosity so they are easy to apply but yet a high enough service temperature that the adhesive will perform satisfactorily when worn at body temperature. The adhesives of the present invention have a surprisingly high ShearAdhesion Failure Temperature in formulations where the viscosity is low enough for easy application. This provides a significant advantage over the use of other block copolymers in preparing hot melt construction adhesives. Another advantage is that the polymers of this invention give adequate performance in formulations containing lesser concentrations of polymer as compared to conventional block copolymers. In nearly all commercial hot melt construction adhesives employing block copolymers, the block copolymer is one of the most expensive components in the formulation. Thus, the block copolymers of the present invention give lower cost adhesives as compared to conventional block copolymers.

### EXAMPLES AND COMPARATIVE EXAMPLES

The following examples are provided to illustrate the present invention. The examples are not intended to limit the scope of the present invention and they should not be so interpreted. Amounts are in parts by weight or weight percentages unless otherwise indicated.

### Examples 1-7

Pressure sensitive adhesives were prepared using block copolymer A. Block copolymer A was a styrene-isoprene-styrene-isoprene block copolymer having the following characteristics: molecular weight (kg/mole): S1=28, B1=247, S2=28, B2=40, polystyrene content=22 percent, W=6.2. The block copolymer was admixed with an aliphatic hydrocarbon tackifying resin sold under the trade designation Piccotac 95 by EASTMAN and a petroleum plasticizing oil sold under the trade designation Shellflex 371 by SHELL. The adhesive components in the quantities shown in Table 1 along with 0.1 percent Irganox 1010 antioxidant sold by Ciba were mixed at 40 percent solids in toluene and cast upon a Mylar film. After evaporation of the toluene, the adhesive properties were tested and the results reported in Table 1.

TABLE 1

| | 1 | 2 | 3 | 4 | 5 | 6 | 7 |
|---|---|---|---|---|---|---|---|
| Block | 15 | 20 | 25 | 30 | 30 | 40 | 50 |
| Copoly- | | | | | | | |
| mer | | | | | | | |
| A (Wt %) | | | | | | | |
| Tackifying | 60 | 60 | 60 | 60 | 50 | 50 | 50 |
| Resin | | | | | | | |
| (Wt %) | | | | | | | |
| Plasti- | 25 | 20 | 15 | 10 | 20 | 10 | 0 |
| cizing | | | | | | | |
| Oil | | | | | | | |
| (Wt %) | | | | | | | |
| Rolling | 10 | 17 | 2 | 16 | 1 | 3 | 13 |
| Ball Tack | | | | | | | |
| Polyken | 0.51 | 0.66 | 0.93 | 1.11 | 0.62 | 0.73 | 0.80 |
| Probe | | | | | | | |
| Tack | | | | | | | |
| 180° Peel | 3.1* | 2.2* | 3.6* | 4.6** | 5.9** | 6.5** | 6.8 |
| Holding | — | — | — | — | 7 | >100 | >100 |
| Power | | | | | | | |
| SAFT | 87 | 96 | 102 | 111 | 111 | 139 | 149 |

*Cohesive failure wherein Mylar and steel plate have adhesive residue.
**Partial cohesive failure.

### Comparative Examples A-G

Pressure sensitive adhesives were prepared using block copolymer B. Block copolymer B was a conventional styrene-isoprene-styrene polymer which was made by coupling a styrene-isoprene diblock polymer. Block Copolymer B had the following characteristics: molecular weight (kg/mole): S1=15.5, B1=180, S2=15.5, polystyrene content=22 percent, uncoupled diblock content=18 percent. Block copolymer B was used to prepare pressure sensitive adhesives substantially identically to Examples 1-7 and the results reported in Table 2.

TABLE 2

| | A | B | C | D | E | F | G |
|---|---|---|---|---|---|---|---|
| Block | 15 | 20 | 25 | 30 | 30 | 40 | 50 |
| Copolymer | | | | | | | |
| B (Wt %) | | | | | | | |
| Tackifying | 60 | 60 | 60 | 60 | 50 | 50 | 50 |
| Resin | | | | | | | |
| (Wt %) | | | | | | | |
| Plasticizing | 25 | 20 | 15 | 10 | 20 | 10 | 0 |
| Oil (Wt %) | | | | | | | |
| Rolling | 12 | >30 | >30 | >30 | 1 | 10 | >30 |
| Ball Tack | | | | | | | |
| Polyken | 0.70 | 0.22 | 0.48 | 0.20 | 0.69 | 0.79 | 0.90 |
| Probe Tack | | | | | | | |
| 180° Peel | 2.8* | 3.1* | 4.1* | 11* | 4.6** | 5.0** | 5.7 |
| Holding | — | — | — | — | 8 | >100 | >100 |
| Power | | | | | | | |
| SAFT | 82 | 90 | 94 | 102 | 101 | 118 | 132 |

*Cohesive failure wherein Mylar and steel plate have adhesive residue.
**Partial cohesive failure.

Comparison of results in Tables 1 and 2 shows that, at a given polymer content, block copolymer A gives the highly desirable result that it gives about a 5° C. to about a 20° C. higher SAFT than the conventional block copolymer B.

### Examples 8-10

Hot melt construction adhesives were prepared using block copolymerA. Block copolymer A was admixed with an aromatic modified aliphatic hydrocarbon tackifying resin which was sold under the trade designation Escorez 5600 by ExxonMobil and a plasticizing oil sold under the trade designation Tufflo 6056 by CITGO. The adhesive components in the quantities shown in Table 3 along with 0.25 percent Irganox 1010 antioxidant were mixed as hot melts in a sigma blade mixer for about 45 minutes at 175° C. Adhesive melt viscosity was measured at 150° C. The hot melt adhesives were then dissolved at 50 percent in toluene and cast on Mylar. After evaporation of the toluene, 180° peel and SAFT were measured. The results are shown below in Table 3.

### Comparative Examples H-J

Hot melt construction adhesives were prepared and tested substantially identically to Examples 8-10 except that the conventional block copolymer B was used as the block copolymer. The results are shown below in Table 3.

TABLE 3

| | 8 | 9 | 10 | H | I | J |
|---|---|---|---|---|---|---|
| Block Copolymer | 11 | 15 | 20 | | | |
| A (Wt %) | | | | | | |
| Block Copolymer | | | | 11 | 15 | 20 |
| B (Wt %) | | | | | | |
| Tackifying Resin | 64 | 64 | 64 | 64 | 64 | 64 |
| (Wt %) | | | | | | |
| Plasticizing Oil | 25 | 21 | 16 | 25 | 21 | 16 |
| (Wt %) | | | | | | |
| 180° Peel | 5.2 | 5.9 | 7.9 | 4.8 | 6.0 | 8.4 |
| SAFT | 79 | 82 | 91 | 66 | 72 | 73 |
| Melt Viscosity | 5.7 | 19.5 | 106 | 1.2 | 2.9 | 9.2 |

Results in Table 3 show again that, at a given polymer content, block copolymer A gives SAFT values about 10° C. to about 18° C. higher than the conventional block copolymer B. Results also show that an SAFT value of 75° C. can be achieved using only about 10 percent of block copolymer A in the formulation whereas about 20 percent of the conventional block copolymer B is required to achieve an SAFT value of 75° C. Since the block copolymer is usually more expensive than the resin and oil, block copolymer A will give lower cost adhesives than the conventional block copolymer B.

1. A pressure sensitive adhesive comprising a tackifying resin and a block copolymer having the general formula: S1-B1-S2-B2
wherein S1, B1, S2, and B2 are polymer blocks, and
B1 is a block of polymerized conjugated diene comprising at least 50 mole percent isoprene having an apparent weight average molecular weight of from about 150,000 to about 400,000;
S1 and S2 are blocks of polymerized monovinylaromatic hydrocarbon having a weight average molecular weight of about 12,000 to about 40,000; and
B2 is a block of polymerized conjugated diene comprising at least 50 mole percent isoprene having an apparent weight average molecular weight of from about 15,000 to about 60,000; and
wherein:
the adhesive has a shear adhesion failure temperature of at least 75° C.;
the weight ratio of B1 over B2 is from about 3.0 to about 12.0; and
the content of polymerized monovinylaromatic hydrocarbon is from about 10 to about 35 weight percent.

2. The adhesive of claim 1 wherein the polymer blocks B1 and B2 each independently comprise at least 80 mole percent isoprene.

3. The adhesive of claim 2 wherein the polymer blocks B1 and B2 each independently comprise at least 99 mole percent isoprene.

4. The adhesive of claim 1 wherein the polymer blocks S1 and S2 each independently comprise at least 80 mole percent styrene.

5. The adhesive of claim 4 wherein the polymer blocks S1 and S2 each independently comprise at least 99 mole percent styrene.

6. The adhesive of claim 1, wherein the polymer block B1 has an apparent weight average molecular weight of from about 250,000 to about 350,000.

7. The adhesive of claim 1, wherein the polymer block B2 has an apparent weight average molecular weight of from about 25,000 to about 50,000

8. The adhesive of claim 1, wherein the polymer blocks S1 and S2 each independently have a weight average molecular weight of from about 20,000 to about 35,000.

9. The adhesive of claim 1, wherein the weight ratio of B1 over B2 is from about 4.0 to about 8.0.

10. The adhesive of claim 1, wherein the weight ratio of B1 over B2 is about 6.0.

11. The adhesive of claim 1, wherein for every 100 parts by weight of the block copolymer, the adhesive additionally comprises from about 25 to about 300 parts by weight of at least one tackifying resin, and from about zero to about 200 parts by weight of a plasticizing oil.

12. The adhesive of claim 1 wherein the tackifying resin is selected from the group consisting of C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosin esters, rosin derivatives, polyterpene resins and mixtures thereof.

13. The adhesive of claim 11 wherein the plasticizing oil is selected from the group consisting of petroleum-based oils having an aromatics content of less than about 50 weight percent.

14. The adhesive of claim 1 additionally comprising an arene-compatible-resin selected from the group consisting of coumarone-indene resin, polyindene resin, polystyrene resin, vinyltoluene-alphamethylstryene copolymer resin, alphamethylstryene resin and mixtures thereof.

15. A composition comprising a substrate and adherent thereto the adhesive of claim 1.

16. The composition of claim 15 wherein the composition is a tape, a label, or a disposable article.

17. The composition of claim 16 wherein the composition is a tape.

18. The composition of claim 16 wherein the composition is a disposable article.

19. The composition of claim 15 wherein the pressure sensitive adhesive is applied as a hot melt.

20. An adhesive tape comprising a tape and adherent to at least one side of the tape, the adhesive of claim 1.
